(19) United States
(12) Patent Application Publication
(10) Pub. No.: US 2021/0323053 A1
(43) Pub. Date: Oct. 21, 2021

(54) Nozzle Temperature Control Techniques for Magnetohydrodynamic Jetting of Metals in 3D Applications

(71) Applicant: Desktop Metal, Inc., Burlington, MA (US)

(72) Inventors: Mark Gardner Gibson, Carlisle, MA (US); Julian Bell, Jamaica Plain, MA (US); Emanuel Michael Sachs, Newton, MA (US); Nicholas Bandiera, Burlington, MA (US)

(73) Assignee: Desktop Metal, Inc., Burlington, MA (US)

(21) Appl. No.: 17/232,343

(22) Filed: Apr. 16, 2021

Related U.S. Application Data
(60) Provisional application No. 63/010,755, filed on Apr. 16, 2020.

(51) Int. Cl. B22D 23/00; B33Y 10/00; B33Y 30/00; B33Y 50/02

(52) U.S. Cl. CPC B22D 23/003; B33Y 50/02; B33Y 30/00; B33Y 10/00

(57) ABSTRACT

A nozzle assembly for metal additive manufacturing using magnetohydrodynamic jetting. A nozzle defines a reservoir and a discharge region having a discharge orifice. A thick film heating system disposed on an exterior of the nozzle and including a first contact pad and a second contact pad connected by a heating pathway heats build material in the nozzle to a liquid state. A first electrode and a second electrode together configured to deliver an electrical current through the liquid build material in the discharge region while a magnet system delivers a magnetic field perpendicular the electrical current, thereby jetting liquid metal to form successive build layers.

### FIELD OF THE DISCLOSURE

The subject matter of the present disclosure generally relates to magnetohydrodynamic jetting for additive manufacturing, and more particularly relates to nozzle heating techniques for magnetohydrodynamic jetting.

### BACKGROUND OF THE DISCLOSURE

Controlled magnetohydrodynamic pulsing may be used to selectively jet individual drops of molten metals and additively build up three-dimensional geometries, in a process known as magnetohydrodynamic printing (here referred to as MHD printing, or MHD). In one embodiment of this process, a jetting apparatus (here referred to as the nozzle assembly) is employed to heat solid metal feedstock above its liquidus temperature to create molten metal, contain the molten metal, keep the molten metal above its liquidus temperature, position the body of molten metal relative to a magnetic field, enable an electric current to be passed through the molten metal to create a magnetohydrodynamic pulse, and direct the flow of molten metal towards the desired target. Certain magnetohydrodynamic printing concepts and apparatus are disclosed by U.S. Pat. No. 10,201,854, entitled “Magnetohydrodynamic deposition of metal in manufacturing” and filed Mar. 6, 2017, the entire contents of which are incorporated herein in their entirety.

Application of heat to the nozzle is an important aspect of MHD printing. Enough heat must be applied to the nozzle to melt the solid feedstock, and also keep the molten metal in the nozzle within an optimal temperature range for jetting. However, applying too much heat may change nozzle operating parameters, damage or prematurely reduce the life of the nozzle, the heating elements providing heat to the nozzle, the structural elements supporting the nozzle, sensors attached to the nozzle, and other components mechanically attached to the nozzle or combined with the nozzle, which comprise the nozzle assembly, or unnecessarily increase the power consumption of the printer. Consequently, developing techniques for providing the optimal amount of heat to a nozzle, particularly as nozzle operating conditions change, is valuable for the operation of MHD printers.

The subject matter of the present disclosure is directed to overcoming, or at least reducing the effects of, one or more of the problems set forth above.

### BRIEF SUMMARY OF THE DISCLOSURE

Disclosed is a nozzle assembly for metal additive manufacturing using MHD jetting. In certain embodiments, a nozzle defines a reservoir and a discharge region having a discharge orifice. A first electrode and a second electrode together deliver an electrical current through the build material in the discharge region. At the same time, a magnet system delivers a magnetic field perpendicular the electrical. The nozzle is heated at least in part by a thick film heating system including at least first contact pad and a second contact pad connected by a heating pathway.

In practice, a build material is fed into the reservoir and the discharge region. The build material is heated to a liquid state. The magnetic field and electrical current provide a jetting force to eject liquid metal from the discharge orifice. The nozzle is moved relative to a build plate to deposit successive layers of metal to form three-dimensional parts.

### BRIEF DESCRIPTION OF THE DRAWINGS

The foregoing summary, preferred embodiments, and other aspects of the present disclosure will be best understood with reference to a detailed description of specific embodiments, which follows, when read in conjunction with the accompanying drawings, in which:

FIG. 1 is a block diagram of an additive manufacturing system for MHD printing molten metal.

FIGS. 2A-C are depictions of the nozzle of the system of FIG. 1.

FIGS. 3A-B depict a first embodiment nozzle assembly.

FIGS. 4A-B depict a second embodiment nozzle assembly.

FIGS. 5A-C depict a third embodiment nozzle assembly.

FIGS. 6A-B depict a fourth embodiment nozzle assembly.

FIG. 7 depicts a fifth embodiment nozzle assembly.

Like reference numbers and designations in the various drawings indicate like elements.

### DETAILED DESCRIPTION

Disclosed are systems and methods for a nozzle assembly configured to heat a build material to be ejected via MHD jetting.

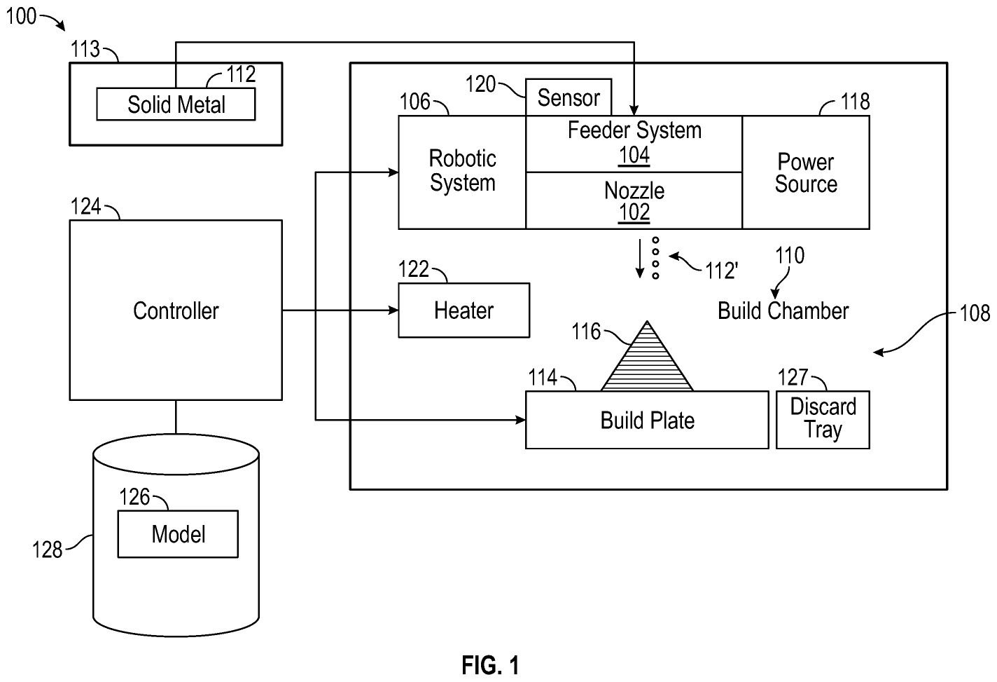

FIG. 1 is a schematic depiction of an additive manufacturing system 100 using MHD printing of liquid metal 100 in which the disclosed improvements may be employed. Additive manufacturing system 100 can include a nozzle 102, a feeder system 104, and a robotic system 106. In general, the robotic system 106 can move the nozzle 102 along a controlled pattern within a working volume 108 of a build chamber 110 as the feeder system 104 moves a solid metal 112 from a metal supply 113 and into the nozzle 102. As described in greater detail below, the solid metal 112 can be melted via heater 122 in or adjacent to the nozzle 102 to form a liquid metal 112′ and, through a combination of a magnetic field and an electric current acting on the liquid metal 112′ in the nozzle 102, MHD forces can eject the liquid metal 112′ from the nozzle 102 in a direction toward a build plate 114 disposed within the build chamber 110. Through repeated ejection of the liquid metal 112′ as the nozzle 102 moves along the controlled pattern, an object 116 (e.g., a two-dimensional object or a three-dimensional object) can be formed. The object may be formed based on a model 126 enacted through a controller 124. In certain embodiments, the object 116 can be moved under the nozzle 102 (e.g., as the nozzle 102 remains stationary). For example, in instances in which the controlled pattern is a three-dimensional pattern, the liquid metal 112′ can be ejected from the nozzle 102 in successive layers to form the object 116 through additive manufacturing. Thus, in general, the feeder system 104 can continuously, or substantially continuously, provide build material to the nozzle 102 as the nozzle 102 ejects the liquid metal 112′, which can facilitate the use of the three-dimensional printer 100 in a variety of manufacturing applications, including high volume manufacturing of metal parts. As also described in greater detail below, MHD forces can be controlled in the nozzle 102 to provide drop-on-demand delivery of the liquid metal 112′ at rates ranging from about one liquid metal drop per hour to thousands of liquid metal drops per second and, in certain instances, to deliver a substantially continuous stream of the liquid metal 112′. A sensor or sensors 120 may monitor the printing process as discussed further below.

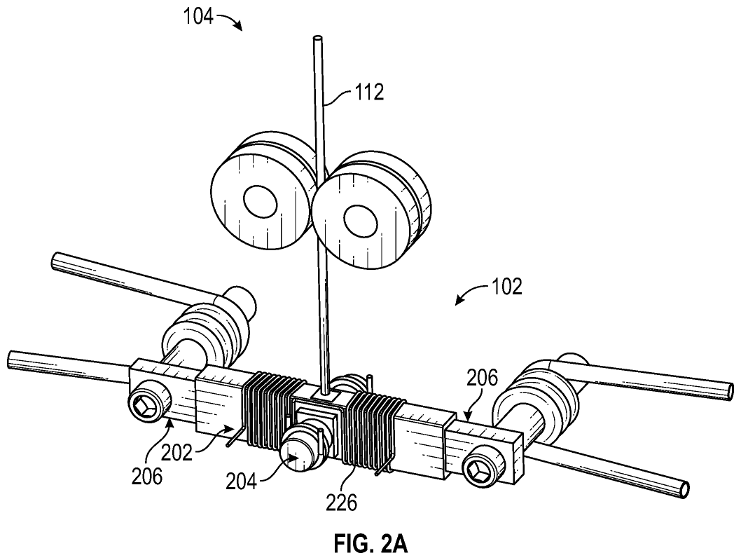

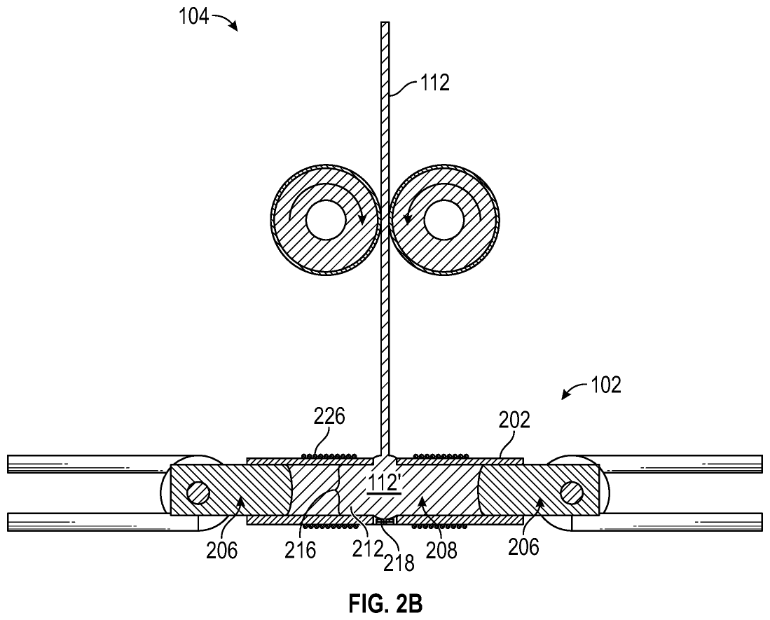

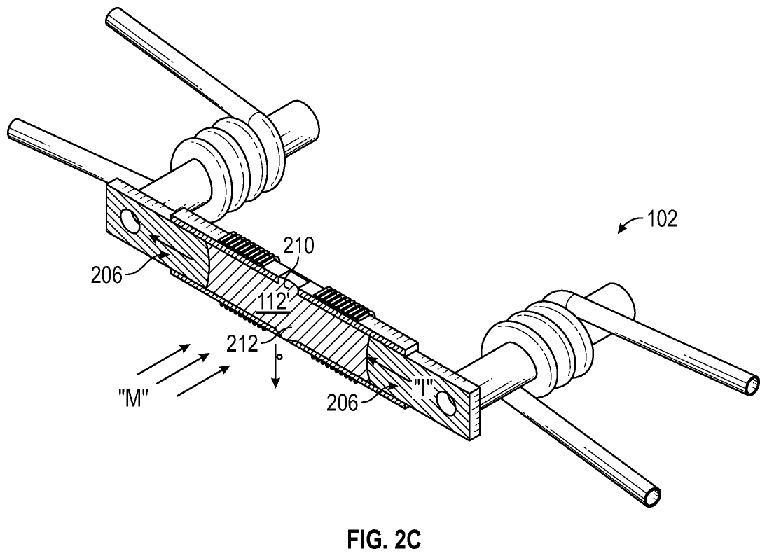

Now with reference to FIGS. 2A-D which depict the nozzle of the printer of FIG. 1. The nozzle can include a housing 202, one or more magnets 204, and electrodes 206. The housing 202 can define at least a portion of a fluid chamber 208 having an inlet region 210 and a discharge region 212. The one or more magnets 204 can be supported on the housing 202 or otherwise in a fixed position relative to the housing 202 with a magnetic field “M” generated by the one or more magnets 204 directed through the housing 202. In particular, the magnetic field can be directed through the housing 202 in a direction intersecting the liquid metal 112′ as the liquid metal 112′ moves from the inlet region 210 to the discharge region 212. Also, or instead, the electrodes 206 can be supported on the housing 202 to define at least a portion of a firing chamber 216 within the fluid chamber 208, between the inlet region 210 and the discharge region 212. In use, the feeder system 104 can engage the solid metal 112 and, additionally or alternatively, can direct the solid metal 112 into the inlet region 210 of the fluid chamber 208 as the liquid metal 112′ is ejected through the discharge orifice 218 through MHD forces generated using the one or more magnets 204 and the electrodes 206. A heater 226 may be employed to heat the housing 202 and the fluid chamber 208 to melt the solid metal 112. A discard tray 127 is located in proximity to the build plate and the nozzle may deposit droplets in it during a testing or calibration step.

In certain implementations, an electric power source 118 can be in electrical communication with the electrodes 206 and can be controlled to produce an electric current “I” flowing between the electrodes 206. In particular, the electric current “I” can intersect the magnetic field “M” in the liquid metal 112′ in the firing chamber 216. It should be understood that the result of this intersection is an MHD force (also known as a Lorentz force) on the liquid metal 112′ at the intersection of the magnetic field “M” and the electric current “I”. Because the direction of the MHD force obeys the right-hand rule, the one or more magnets 204 and the electrodes 206 can be oriented relative to one another to exert the MHD force on the liquid metal 112′ in a predictable direction, such as a direction that can move the liquid metal 112′ toward the discharge region 212. The MHD force on the liquid metal 112′ is of the type known as a body force, as it acts in a distributed manner on the liquid metal 112′ wherever both the electric current “I” is flowing and the magnetic field “M” is present. The aggregation of this body force creates a pressure which can lead to ejection of the liquid metal 112′. It should be appreciated that orienting the magnetic field “M” and the electric current substantially perpendicular to one another and substantially perpendicular to a direction of travel of the liquid metal 112′ from the inlet region 210 to the discharge region 212 can result in the most efficient use of the electric current “I” to eject the liquid metal 112′ through the use of MHD force.

In use, the electrical power source 118 can be controlled to pulse the electric current “I” flowing between the electrodes 206. The pulsation can produce a corresponding pulsation in the MHD force applied to the liquid metal 112′ in the firing chamber 216. If the impulse of the pulsation is sufficient, the pulsation of the MHD force on the liquid metal 112′ in the firing chamber 208 can eject a corresponding droplet from the discharge region 212.

In certain implementations, the pulsed electric current “I” can be driven in a manner to control the shape of a droplet of the liquid metal 112′ exiting the nozzle 102. In particular, because the electric current “I” interacts with the magnetic field “M” according to the right-hand rule, a change in direction (polarity) of the electric current “I” across the firing chamber 216 can change the direction of the MHD force on the liquid metal 112′ along an axis extending between the inlet region 210 and the discharge region 212. Thus, for example, by reversing the polarity of the electric current “I” relative to the polarity associated with ejection of the liquid metal 112′, the electric current “I” can exert a pullback force on the liquid metal 112′ in the fluid chamber 208.

Each pulse can be shaped with a pre-charge that applies a small, pullback force (opposite the direction of ejection of the liquid metal 112′ from the discharge region 212) before creating an ejection drive signal to propel one or more droplets of the liquid metal 112′ from the nozzle 102. In response to this pre-charge, the liquid metal 112′ can be drawn up slightly with respect to the discharge region 212. Drawing the liquid metal 112′ slightly up toward the discharge orifice in this way can provide numerous advantageous, including providing a path in which a bolus of the liquid metal 112′ can accelerate for cleaner separation from the discharge orifice as the bolus of the liquid metal is expelled from the discharge orifice, resulting in a droplet with a more well-behaved (e.g., stable) shape during travel. Similarly, the retracting motion can effectively spring load a forward surface of the liquid metal 112′ by drawing against surface tension of the liquid metal 112′ along the discharge region 212. As the liquid metal 112′ is then subjected to an MHD force to eject the liquid metal 112′, the forces of surface tension can help to accelerate the liquid metal 112′ toward ejection from the discharge region 212.

Further, or instead, each pulse can be shaped to have a small pullback force following the end of the pulse. In such instances, because the pullback force is opposite a direction of travel of the liquid metal 112′ being ejected from the discharge region 212, the small pullback force following the end of the pulse can facilitate clean separation of the liquid metal 112′ along the discharge region 212 from an exiting droplet of the liquid metal 112′. Thus, in some implementations, the drive signal produced by the electrical power source 118 can include a wavelet with a pullback signal to pre-charge the liquid metal 112′, an ejection signal to expel a droplet of the liquid metal, and a pullback signal to separate an exiting droplet of the liquid metal 112′ from the liquid metal 112′ along the discharge region 212. Additionally, or alternatively, the drive signal produced by the electrical power source 118 can include one or more dwells between portions of each pulse.

As used herein, the term “liquid metal” shall be understood to include metals and metal alloys in liquid form and, additionally or alternatively, includes any fluid containing metals and metal alloys in liquid form, unless otherwise specified or made clear by the context. Metals suitable for use with the disclosure include aluminum and aluminum alloys, copper and copper alloys, silver and silver alloys, gold and gold alloys, platinum and platinum alloys, iron and iron alloys, and nickel and nickel alloys.

It is helpful to distinguish the terms “nozzle” and “nozzle assembly” as used herein. The term “nozzle” generally refers to a structure used to contain and direct the flow of molten metal used in MHD printing. It may preferably be manufactured from one or more materials that can withstand high temperatures and is resistant to degradation by the molten metal being used. In certain embodiments, the nozzle is manufactured from alumina ceramic.

The term “nozzle assembly” describes the combination of the nozzle with other components that are valuable or imperative for its use in MHD jetting, and which provide additional functionality beyond containing and directing the flow of molten metal. For example, in certain embodiments the nozzle assembly may include:
a heating system for supplying heat to the nozzle, which melts fresh feedstock and keeps the build material inside of the nozzle in the molten state;
temperature sensing elements, such as thermocouples, to enable close control of the print material's temperature;
electrodes, to direct a current pulse into and through the molten print material;
magnets, which may be permanent magnets or electromagnets, to create a magnetic field that contains the molten metal;
apparatus such as heat sinks or water-cooling channels for removing heat from different regions of the nozzle assembly, such as the electrodes or magnets;

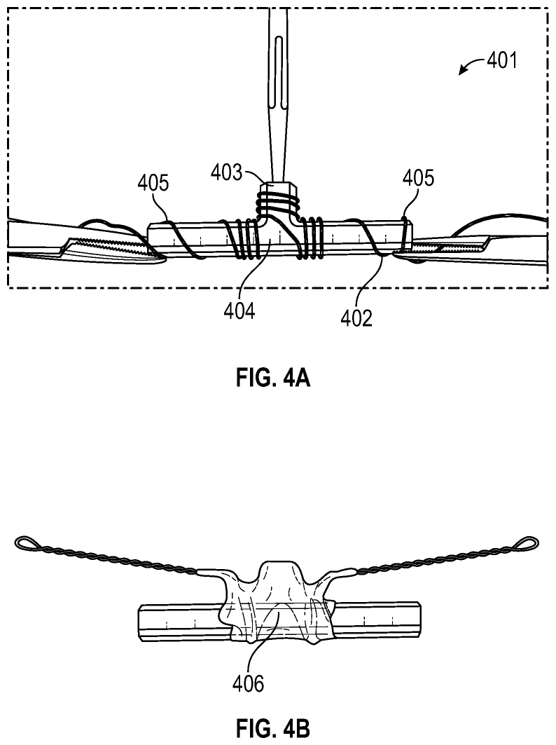

The current disclosure relates to the design of heating systems for nozzles used in MEM printing, and to methods for using these heating systems. A heating system for a nozzle generally includes one or more heat sources. These heat sources may be implemented using a wide variety of techniques that will be familiar to those skilled in the art, but are preferably implemented using resistance heating elements. The heating system also comprises one or more means of driving the heat sources, such as temperature controllers. The heating system may also incorporate one or more sensors for detecting heat flow or temperature. Examples of these sensors include thermocouples, pyrometers, and mechanical strain sensors, among others. If such sensors are included, the means of driving the heat sources may be connected to the sensors, to provide closed-loop control of temperature or heat flow. In certain embodiments, a resistance heating element is implemented using a wire made from high-resistance alloy, such as a nickel-chromium (Nichrome) or iron-aluminum-chromium (Kanthal®) alloy wire. In a certain embodiments, the wire may be wrapped around the nozzle body and secured in place using mechanical means such as a ceramic adhesive, as shown in FIG. 4. In other embodiments, the wire may be embedded in the surface of a third component using mechanical means such as a ceramic potting compound; the third component is then placed in contact with the nozzle during operation to provide heat to the nozzle. In some embodiments, this third component is a permanent part of the printer, and thus not changed when the nozzle is changed.

In other embodiments, the element is implemented using a flat strip made from high-resistance alloy. This embodiment may reduce the profile of the heating element, and improve manufacturability. The flat strip may be machined, bent or otherwise pre-formed to have a specific shape. In certain embodiments, this shape has a constant cross-sectional area in the direction of current flow such that the resistance at each section along the strip is constant, and the heat generated at each section along the strip is constant. In other embodiments, the cross-sectional area of the strip is varied slightly to provide different heat generation profiles at different locations along the strip. The strip may be further formed in a shape that conforms to a nozzle body, and then bonded to that nozzle body using mechanical means such as a high-temperature ceramic adhesive. The strip may also be embedded in the surface of a third component using mechanical means such as a ceramic potting compound; the third component is then placed in contact with the nozzle during operation to provide heat to the nozzle.

In certain embodiments, a thick-film coating process is used to create a resistive heating element directly on the surface of a part. This part may be a nozzle. It may also be a second component which is placed in contact with the nozzle during operation to provide heat to the nozzle. The geometry of this element may be defined using a variety of techniques familiar to those skilled in the art, such as masking. In this manner, the geometry of the element may be optimized to provide different amounts of heat generated at different points along the element's length.

In other embodiments, a large ceramic element may be used as a resistive heating element. This heating element may be made from materials such as molybdenum disilicide or silicon carbide. The heating element may be manufactured separately from the nozzle, and placed in contact with it during operation to provide heat to the nozzle. In other embodiments, the heating element is formed as an integral part of the nozzle, through techniques such as injection molding, co-firing or diffusion bonding.

As is made clear in the descriptions of the preceding embodiments, resistance heating elements may be manufactured integrally with the nozzle, or in one or more parts that are combined in the nozzle assembly.

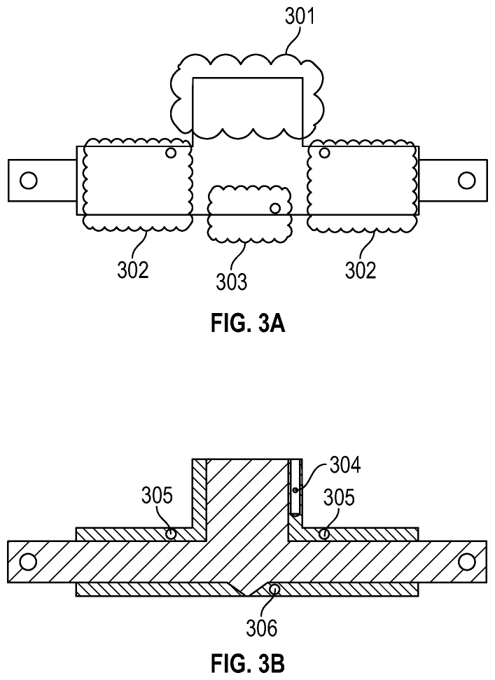

Heat sources may be applied to a nozzle in a variety of locations. It may also be preferable to apply one or more heat sources to a nozzle. In certain embodiments, a nozzle is provided with four distinct heat sources, as shown in FIGS. 3A-B. The heaters are applied at the point where solid feedstock enters the nozzle and is melted, referred to here as the reservoir heating system 301. At the points where electrical terminals make contact with the molten metal inside the nozzle there are terminal heaters 302, which may be controlled together or independently. Around the location where material is ejected from the nozzle during jetting there is nozzle exit heater system 303. These heat sources may be implemented using different techniques. For example, it may be preferable to implement the reservoir heat system using a ceramic element attached externally to the nozzle, while implementing the nozzle exit heater system 303 using a thick-film technique applied directly to the nozzle.

When implementing multiple heat sources, it may be preferable to also control the heat sources separately to provide specific effects, such as decoupling temperature control between different regions of the nozzle. For example, it may be preferable to apply more heat to the reservoir than the nozzle exit, to ensure that cold feedstock entering the reservoir does not freeze the material in the reservoir. This may be done by implementing one or more heat source drivers, defined as variable electrical power sources with control systems, which can provide power to one or more heaters based on certain inputs (known a process control variables) and programmed algorithms, such as a PID control. In the simplest embodiment, each heat source driver independently controls one area of the nozzle based on a temperature measurement in that area. In another embodiment, a more sophisticated multi-input, multi-output (MIMO) controller is implemented, which can compensate for dynamic thermal interactions between different heater circuits as well as other nozzle heat sources and sinks, such as stock feeding, resistive heating during jetting, or drop ejection.

These heat source drivers may also be aware of the operating parameters of other heat source drivers. For example, the heat source driver controlling the nozzle exit heater system 303 may have as an input the temperature or heat flow being commanded by the heat source driver controlling the reservoir heater system 301, and reduce or increase its output appropriately to accommodate greater or reduced heat flow from the reservoir into the nozzle exit Further, a “feed-forward” control could be used with any of these methods. For example, the reservoir heater control algorithm could be programmed to increase power to the reservoir heater by a certain amount when the wire feeder is started, since the incoming wire requires more heat to melt.

In addition to operating separate heaters in different ways simultaneously, heating systems may be operated in different ways at different times during nozzle operation. In certain embodiments, during initial nozzle warm-up when the nozzle is not required to jet, heaters located at the nozzle exit and nozzle terminals may be deactivated, and only the nozzle reservoir heater activated. This may have the benefit of reducing fatigue on heating elements; and reducing thermal strain on fragile elements of the nozzle by enabling them to heat more slowly.

Heating systems may also incorporate means of detecting the temperature and/or heat flow at different points throughout the nozzle. As described earlier, these means may include sensor systems such as thermocouples, pyrometers, and mechanical strain sensors. There may be more than one sensor system applied to a nozzle. preferably, there is one or more sensor system for each heating system installed on a nozzle. Preferably, a given sensor system is located at or nearby the point of action of the heating system it is connected to. For example, in the nozzle shown in FIG. 3B, separate temperature sensors (in this case, thermocouples) include reservoir sensor 304, terminal sensors 305 and nozzle sensor 306 located in respective holes.

In certain embodiments, the techniques described herein to produce thick-film heater traces may be used to create one or more RTD (resistance temperature detector) elements directly on one or more areas of the nozzle. In commercial practice, some RTD elements are made from the same or similar materials as those used for thick-film heater traces (e.g. platinum) in a certain embodiments these RTD elements are screen printed or dispensed in the same manufacturing operation as the heater traces, and are connected to electrically in the same ways (described herein) as well.

In certain embodiments, the temperature-dependent resistivity of a heating element may be used to determine the temperature of the element as it is being used. For example, the resistance of a Kanthal heating element increases by 5% as it is heated from ambient to its maximum service temperature of 1400 C. By precisely measuring the resistance of a heating element (for example, by measuring the voltage across the heating element while a known current is being supplied through the element, in a four-wire configuration), measured changes in that resistance may be used to determine the temperature of the heating element at any instant. This can be done with the heater under power, or during a short interval where power is switched off, which in some cases can give a more accurate measure of the nozzle temperature vs. that of the heater, which will necessarily be higher.

The temperature of the heating element may then be used directly as the process control variable for nozzle temperature control or be incorporated into a more sophisticated temperature control system along with other temperature measurements, such as from thermocouples or other instruments.

In other embodiments, the resistance of the current path through the nozzle is used to detect the temperature of the molten metal, as follows: The terminals are made of the same or similar material as the feedstock, and the nozzle is heated preferentially in its center (for example in the locations heated by reservoir heater system 301 and nozzle exit heater system 303, while the ends of the terminals away from the heated region are cooled. As a result, the material in the region closest to the heaters will melt first, leaving the outer, cooler regions solid. As the melt temperature increases, the boundary between molten and frozen material will move toward the ends; as it decreases, the opposite will occur. Since the jetting current travels from one terminal, through the nozzle, and out the second terminal, it will necessarily travel through the first solid, liquid, and second solid regions. Given the approximate doubling of electrical resistivity of aluminum between solid and molten states, it follows that the movement of the solid-liquid transition described above will cause the relative proportion of liquid to solid material to change—the effect of higher temperature being more molten material, less solid material, and a resulting higher electrical resistance of the current path. By simultaneously measuring the voltage across and current flow through the nozzle during jetting pulses, the resistance may be calculated, and this resistance used as a proxy for the nozzle temperature.

In addition to measured temperature, heating systems may also be controlled by other varying quantities during MHD jetting. For example, heat source driver output may be modulated in real-time by parameters such as feedstock feed rate, printing feed rate, and jetting pulse parameters such as pulse width and amplitude, among others. In this manner, the heating system may proactively provide additional heat flow in a feedforward control architecture, to smooth system thermal response to changes in jetting conditions.

The current flowing through the nozzle during jetting may also be used as a source of heat. The amount of heat delivered may be modulated by changing pulse parameters such as pulse width, amplitude, or frequency, or geometric characteristics of the current path such as nozzle interior geometry or terminal geometry. Furthermore, in a further embodiment where a) the material in the nozzle and/or in the terminals has a resistivity that increases with temperature, and b) the jetting circuit is voltage-controlled rather than current-controlled, the jetting current path may act as a self-regulating heater. As temperature along the current path increases, the resistance of the path will increase. This will cause less current to be driven through the path for a given terminal voltage. The reduced current will substantially decrease Joule heating in the current path, and the current path will cool. In this manner, a self-regulating heating source may be implemented in the nozzle jetting current path.

FIG. 4A depicts a nozzle 401 and the installation of a wire heating system 402, which is shown being wrapped around the reservoir area 403 of the nozzle, the discharge region 404 and the extensions of the nozzle 405.

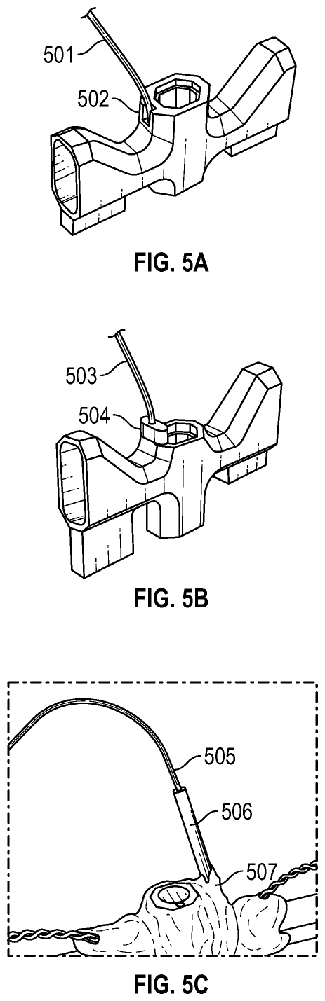

FIG. 5A depicts an embodiment in which a thermocouple 501 has been installed in a recessed, partially enclosed cavity 502 that allows the tip of thermocouple 501 to be located closer to the center of the nozzle. FIG. 5B depicts an embodiment in which a thermocouple 503 has been installed in an enclosed cavity 504 above the nozzle, to protect it from contact with molten metal. FIG. 5C depicts an embodiment in which a thermocouple 505 in a tube 506 is attached to the nozzle after the nozzle is manufactured, for example through bonding with ceramic adhesive 507.

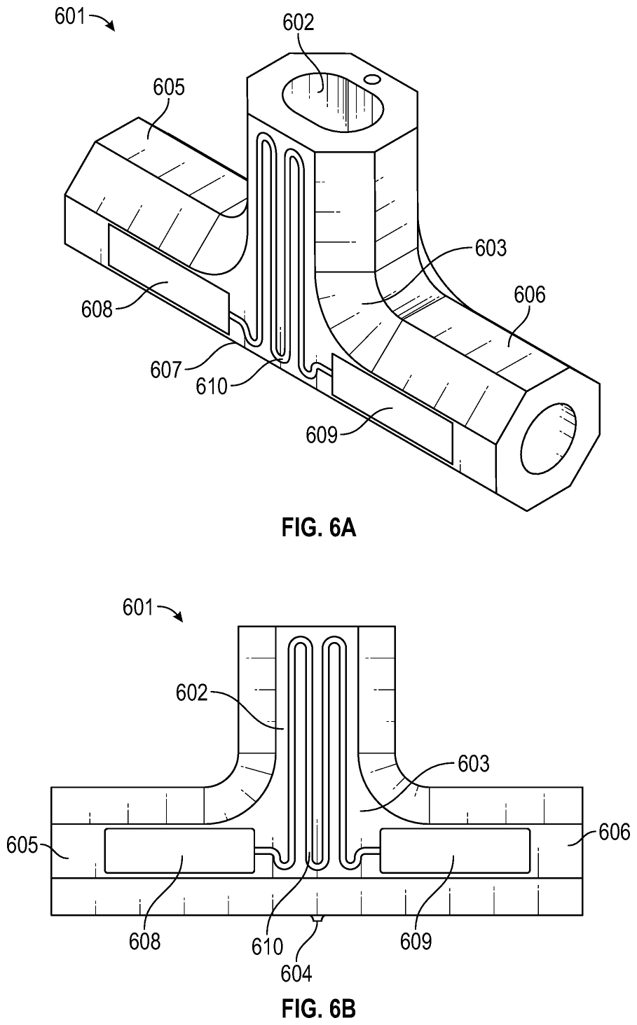

With reference to FIGS. 6A-B, a nozzle 601 defines a reservoir 602, a discharge region 603 having a discharge orifice 604, a first extension 605 and a second extension 606. In operation a first electrode extends into the first extension 605 and a second electrode extends into the second extension 606. In certain embodiments, extensions may not be employed and the electrodes will enter the nozzle directly. Together the electrodes deliver an electrical current through build material in the discharge region while a magnet system delivers a magnetic field perpendicular the electrical current creating a jetting force. Thick film heating system 607 includes a first contact pad 608 connected to a second contact pad 609 via a heating pathway 610.

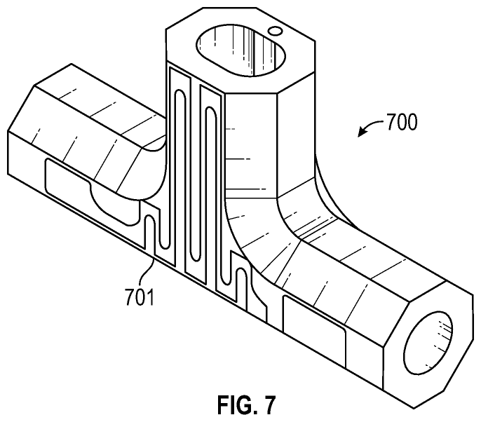

The heating pathway is created using thick film manufacturing techniques familiar to those skilled in the art, such as screen printing or automated robotic dispensing of a commercially-available thick-film heating paste such as ESI5544 from Ferro Corporation, which incorporates platinum, or alternatives incorporating molybdenum, manganese, or tungsten, alone or in combination, followed by drying and firing at a temperature of (for example) 900-1400° C., resulting in a trace with a typical thickness of between 5 um and 30 um. The path, length, and shape of the pathway is designed and optimized to produce a desired total electrical resistance and to selectively apply more or less heat to desired areas of the nozzle body. For example, more heating might be directed to the nozzle tip area. In addition, special shapes at corners may be used to reduce “current crowding”, which is the tendency of current to travel preferentially along the inside of corners, causing excessive heating in these areas and possible trace failure as a result. FIG. 7 depicts a nozzle 700 having such corners 701.

In the case of geometries which do not lend themselves to planar screen printing, robotic dispensing techniques may be used. The paste may be dispensed from a syringe through a needle onto the substrate (i.e. nozzle and/or reservoir surface) by a robot which manipulates the needle and nozzle/reservoir relative to each other in space while advancing the syringe plunger by a controlled amount to dispense the correct amount of material along the path. In one embodiment, a groove is machined, molded or otherwise provided, into the substrate along the desired path, and the needle is manipulated by the robot to slide along the groove, such that the groove controls the needle's position precisely, compensating for inaccuracy in the robot and/or variations in the surface of the substrate or piece-to-piece variations in substrates. In other embodiments, the needle material and dimension is chosen to provide a certain amount of flexibility, this allowing the needle to travel both along and perpendicular to the substrate surface in order to stay in the groove despite the inaccuracies mentioned above. As a non-limiting example, the needle could be made of plastic such as polypropylene.

In one embodiment, screen printing and robotic dispensing techniques could be combined on one substrate.

To deliver electrical current to the heating elements, some form of electrical connection must be employed. In one embodiment using either resistance-wire or thick-film heater traces, electrical power is delivered via lead wires which are welded to the heater element. In certain embodiments of thick-film heating elements, power is delivered through commercially-available spring-loaded contacts known as “pogo pins”, which provide the advantage of requiring no tools to make and break the electrical connections during nozzle installation and/or removal.

One challenge in the design of MHD-based metal printing systems are the conflicting goals of locating the MHD nozzle securely (to prevent unwanted changes in droplet trajectory, for example), while inhibiting as much as possible any transfer of heat from the nozzle to the surrounding parts. A tertiary requirement is to accommodate the ‘growth’ of the nozzle that results from thermal expansion as the nozzle heats from ambient temperature to one sufficient to melt aluminum alloy. In practice, designing for the first goal tends to produce a rigid physical contact with the nozzle, while the second and third require minimizing same. In certain embodiments, the spring pins used to make the electrical connections are also used to physically locate the nozzle, for example by having them designed to sit in slots, dimples or the like in the nozzle body. In an alternative embodiment, the nozzle is physically constrained by other features, and spring pins are designed to prevent them having any effect on the nozzle position or stability. For example the spring force may be chosen to be the minimum required to keep electrical contact (but not enough to push the nozzle away from its nominal position), the tip style might be chosen to be rounded instead of pointed, and/or the pin itself might be mounted with compliance, such that it has no physical retaining effect on the nozzle.

The terms “bottom”, “below”, “top” and “above” as used herein do not necessarily indicate that a “bottom” component is below a “top” component, or that a component that is “below” is indeed “below” another component or that a component that is “above” is indeed “above” another component as such directions, components or both may be flipped, rotated, moved in space, placed in a diagonal orientation or position, placed horizontally or vertically, or similarly modified. Accordingly, it will be appreciated that the terms “bottom”, “below”, “top” and “above” may be used herein for exemplary purposes only, to illustrate the relative positioning or placement of certain components, to indicate a first and a second component or to do both.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed:

1. A nozzle assembly for metal additive manufacturing using magnetohydrodynamic jetting, comprising:
a nozzle defining a reservoir and a discharge region having a discharge orifice;
a first electrode and a second electrode together configured to deliver a deliver an electrical current through the build material in the discharge region;
a magnetic system configured to deliver a magnetic field perpendicular the electrical current to produce a jetting force; and
a thick film heating system including at least a first contact pad and a second contact pad connected by a first heating pathway.

2. The nozzle assembly of claim 1 wherein the thick film heating system is configured to heat the reservoir and the discharge region to substantially liquify the build material contained within the reservoir and the discharge region.

3. The nozzle assembly of claim 2 further comprising a temperature sensing system configured to determine a temperature of the build material in the nozzle.

4. The nozzle assembly of claim 3 wherein the temperature sensing system includes at least one thermocouple.

5. The nozzle assembly of claim 3 wherein the temperature sensing system includes a control system configured to determine a resistance of the build material to the electrical current and correlate the resistance to the temperature of the build material.

6. The nozzle assembly of claim 1 further comprising a cooling system configured to cool at least one component of the nozzle assembly.

7. The nozzle assembly of claim 3 wherein the temperature sensing system includes at least one resistance temperature detector.

8. The nozzle assembly of claim 1 wherein the thick film heating system includes a third contact pad and wherein the thick film heating system includes a first heat zone and a second heat zone.

9. The nozzle assembly of claim 1 wherein the thick film heating system includes a third contact pad and a fourth contact pad contact connected by a second heating pathway.

10. The nozzle assembly of claim 1 wherein a first spring-loaded pin contacts the first contact pad and a second spring-loaded pin contacts the second contact pad.

11. The nozzle assembly of claim 1 wherein the thick film heating system includes a first heating zone configured to heat the reservoir and a second heating zone configured to heat the discharge region.

12. The nozzle assembly of claim 1 wherein the thick film heating system includes: a first heating zone configured to heat the reservoir, a second heating zone configured to heat the discharge region, and a third heating zone configured to heat a first nozzle extension and a second nozzle extension.

13. The nozzle assembly of claim 1 wherein the thick film heating system includes: a first heating zone configured to heat the reservoir, a second heating zone configured to heat the discharge region, a third heating zone configured to heat a first nozzle extension, and a fourth heating zone configured to heat a second nozzle extension.

14. A method of additive manufacturing using magnetohydrodynamic jetting, including the steps of:
providing a nozzle defining a reservoir and having a discharge region having a discharge orifice;
heating a thick film heating system disposed on an exterior of the nozzle to liquify a build material in the reservoir and the discharge region;
delivering a magnetic field through the discharge region along a first axis; and
delivering an electrical current through the build material in the discharge region via the first electrode and the second electrode along a second axis perpendicular to the first axis to produce a jetting force.

15. The method of claim 14 further comprising the step of determining a temperature of the build material in the nozzle via a temperature sensing system.

16. The method of claim 15 wherein the temperature sensing system includes at least one thermocouple.

17. The method of claim 15 wherein the temperature sensing system includes at least one resistance temperature detector.

18. The method of claim 14 wherein the thick film heating system includes a third contact pad and wherein the thick film heating system includes a first heat zone and a second heat zone.

19. The method of claim 14 wherein the thick film heating system includes a third contact pad and a fourth contact pad contact connected by a second heating pathway.

20. The method of claim 14 wherein a first spring-loaded pin contacts the first contact pad and a second spring-loaded pin contacts the second contact pad.

21. A method of manufacturing a nozzle assembly for magnetohydrodynamic jetting, including the steps of:
forming a nozzle defining a reservoir and a discharge region having a discharge orifice;
applying a thick-film heating system layer to an exterior surface of the nozzle including at least a first contact pad and a second contact pad connected by a first heating pathway.

22. The method of claim 21 wherein the thick film heating system includes a third contact pad and wherein the thick film heating system includes a first heat zone and a second heat zone.

23. The method of claim 21 wherein the thick film heating system includes a third contact pad and a fourth contact pad contact connected by a second heating pathway.
